(19) United States
(12) Patent Application Publication
(10) Pub. No.: US 2005/0056287 A1
(43) Pub. Date: Mar. 17, 2005

(54) In-mouth filter for sunless, liquid-spray tanning

(76) Inventor: James T. Botzen, Birmingham, MI (US)

Correspondence Address: John G. Posa;Gifford, Krass, Groh, Sprinkle,, Anderson & Citkowski, P.C., 280N. Old Woodward Ave., Suite 400, Birmingham, MI, 48009-5394, US

(21) Appl. No.: 10/924,682

(22) Filed: Aug. 23, 2004

Related U.S. Application Data
(60) Provisional application No. 60/497,216, filed on Aug. 21, 2003.

(51) Int. Cl. A62B 7/10

(52) U.S. Cl. 128/857; 128/846

(57) ABSTRACT

An in-mouth filter for sunless, liquid-spray tanning comprises a piece of filter material and a body having an in-mouth portion and a filter-receiving portion. In the preferred embodiments, the filter-receiving portion includes a sidewall with an opening for breathing through the filter material and a closed end to shield liquid tanning spray directed at a user. The filter material may be a cotton pad, quilted or otherwise, or any other material suited to the capture of mist particles. One or more filter-material retaining features may be provided within the body, and the in-mouth portion may be oval in cross section for user comfort.

### REFERENCE TO RELATED APPLICATION

This application claims priority from U.S. Provisional Application Ser. No. 60/497,216, filed Aug. 21, 2003, the entire content of which is incorporated herein by reference.

### FIELD OF THE INVENTION

This invention relates generally to air filtering and, in particular, to filters for sunless, liquid-spray tanning applications.

### BACKGROUND OF THE INVENTION

Spray-on, sunless tanning is becoming more popular due to the fast-acting nature of the procedure and the avoidance of ultraviolet radiation. However, even the promoters of the process warn that the tanner should be careful about breathing the fumes. In a recent brochure, Mist-On System, Inc. “recommends that the spray-tanner avoid inhaling or ingesting the solution, and avoid getting it in the eye area or on external mucous membranes. We recommend the following procedures to avoid this exposure. Most tanners avoid this exposure by closing their eyes and holding their breath during the 5-second misting process that occurs each of the four passes of the misting column. You may open your eyes and breathe normally for the 5-7 second pause between each pass. You can almost totally avoid any inhalation, ingestion and exposure to the eye area by covering you face with a hair net during the tanning session. You can tan your face after the misting process by dabbing onto your face the residual tanning solution on the hair net.”

According to Published U.S. patent application No. 20030019504, “[f]or a person to be coated as illustrated in FIG. 2 with an artificial tanning composition (or any composition of the applications aforementioned), several precautions should be taken. First, the person should hold their breath during the application and during the time required for the spray to clear. If this process is done in an open area, the coating should take about 5 to 15 seconds and the clearing of residues should take 1 to 10 seconds. Thus, the person would need to hold their breath for 6 to 25 seconds. Alternatively, they could wear a filter over their mouth, have a filter inside of their mouth, or use a breathing tube.”

Although such disclosure alludes to the need for a breathing appliance, none of them propose a solution to the problem.

### SUMMARY OF THE INVENTION

This invention improves upon the prior art by providing an in-mouth filter for sunless, liquid-spray tanning. The device comprises a piece of filter material and a body having an in-mouth portion and a filter-receiving portion. In the preferred embodiments, the filter-receiving portion includes a sidewall with an opening for breathing through the filter material and a closed end to shield liquid tanning spray directed at a user.

The filter material may be a cotton pad, quilted or otherwise, or any other material suited to the capture of mist particles. One or more filter-material retaining features may be provided within the body, and the in-mouth portion may be oval in cross section for user comfort.

### BRIEF DESCRIPTION OF THE DRAWINGS

FIG. 1 is an isometric view of an embodiment of the invention;

FIG. 2 is a side view of the embodiment of FIG. 1;

FIG. 3 is a front view of the embodiment of FIG. 1;

FIG. 4 is a back view of the embodiment of FIG. 1;

FIG. 5 is a front view of the embodiment of FIG. 1;

FIG. 6 is a front view of the embodiment of FIG. 1;

FIG. 7 is an exploded view of the preferred embodiment of the invention; and

FIG. 8 is an assembled view of the embodiment of FIG. 7.

### DETAILED DESCRIPTION OF THE INVENTION

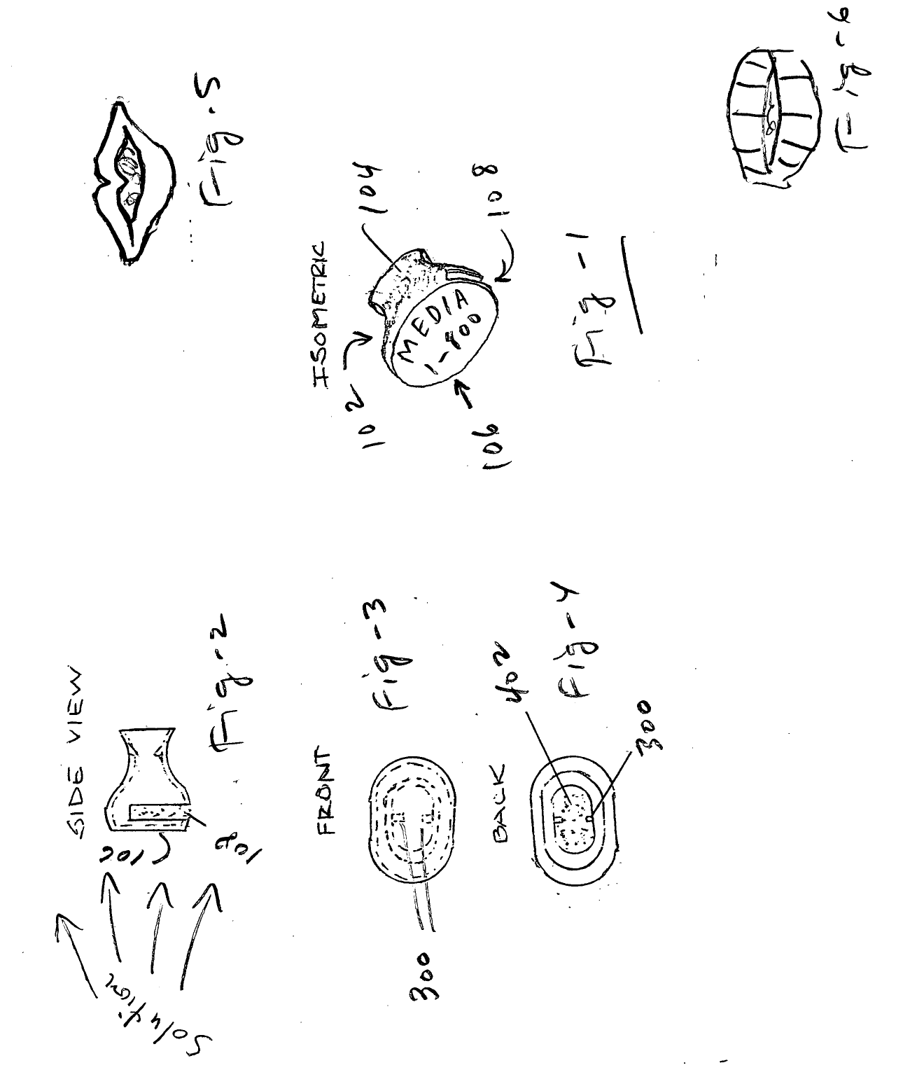

An isometric view of an embodiment of the invention is shown in FIG. 1. The device comprises a relatively small generally hollow body 102, having an in-mouth portion 104, a surface 106 to receive the tanning liquid, and an opening such as 108 through which the person receiving the tanning solution breaths. The device 102 is made as small as possible, so as only to cover the lips of the wearer. Note also, in the preferred design, the surface 106 is ideal for printed matter, such as advertisements, directions, and so forth.

FIG. 2 is a side view of the embodiment of FIG. 1, showing the direction of the tanning solution, in relation to the opening 108. With the opening 108 oriented behind the surface 106, the likelihood is small that any of the liquid will actually impinge upon the filter material stuffed in the body 102. FIG. 3 is a front view of the device, showing how optional prongs 300 may be included to hold the filter material 402 in position.

The device 106 is preferably molded from plastic, and the filter material 402 may be of any appropriate type, having voracity that restricts the passage of mists. Such filters are commercially available and known to those of skill in the art. It may also be possible to integrally mold a porous membrane, rather than stuff the body with filter material. The device 102 is preferably inexpensive enough that it may be sterilely wrapped for each customer, and not reused, though the possibility of a more elaborate version with reusable filter material, for example, is not precluded.

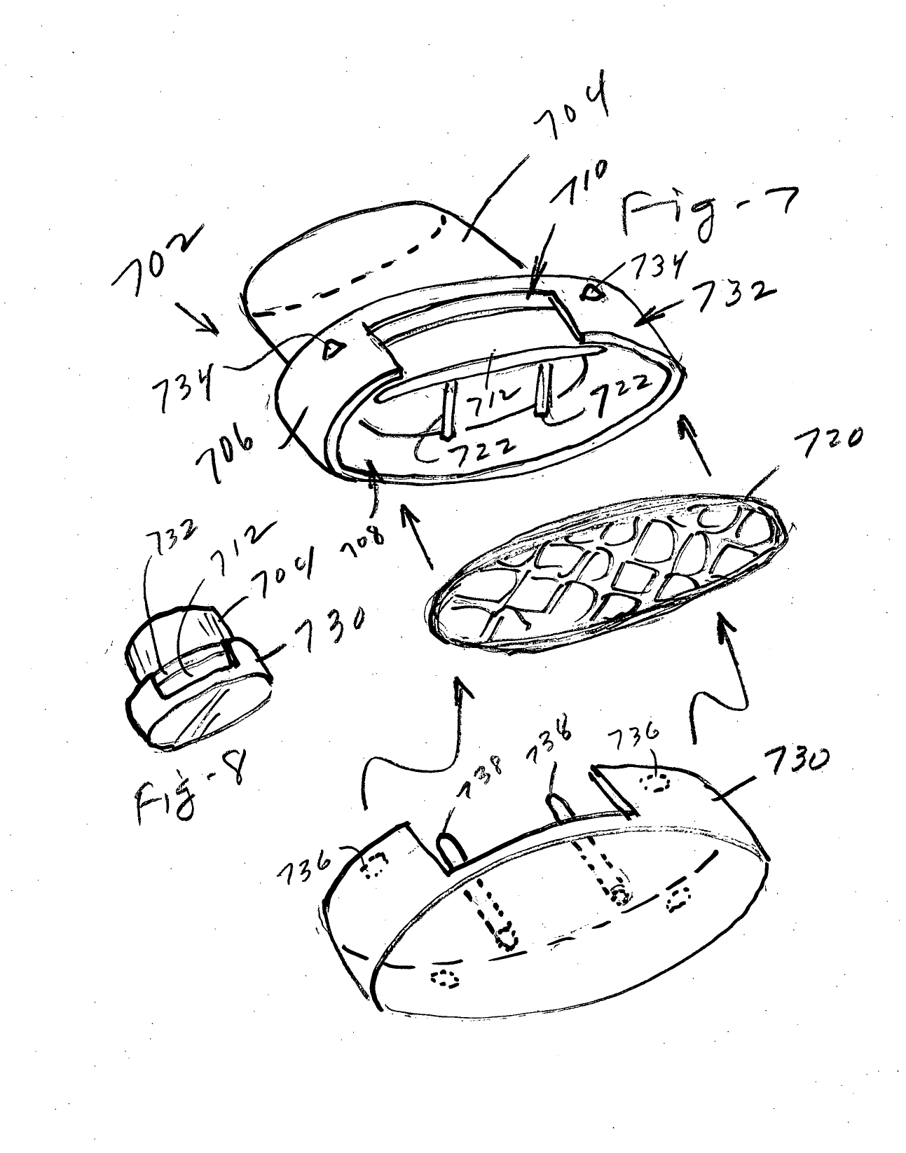

In alternative embodiments of the invention, the device may include a fanciful shape, such as the lips of FIG. 5, or the teeth of FIG. 6.

FIGS. 7 and 8 illustrate a different embodiment of the invention, with FIG. 7 showing an exploded view, and FIG. 8 showing an assembled configuration. Broadly, this embodiment comprises a first component 702 having an in-mouth portion 704 and filter-receiving portion 706, a pad of filter material 720, and a cover 730. The portion 702, 730 may be constructed from any suitable material, such as plastics, and the like, and filter material 720 may be any natural or synthetic material capable of capturing mist particles. Preferably, the filter material 720 is quilted cotton, though quilting is also not necessary to the invention.

Filter-receiving portion 706 of the component 702 includes a shaped cavity 708 which receives the filter material 720. Posts 722 are optionally provided to keep the filter material 720 from traveling too far down the in-mouth portion 704 as the user inhales. A baffle 712 is preferably provided to ensure that all of the air breathed by the user travels through the in-place filter material 720 through opening 710.

The filter-receiving portion 706 includes an outer surface 732 configured to receive an inner surface of cover 730. Tabs 34 are preferably provided on the filter-receiving portion 706, which mate with indents 736 on cover 730, allowing it to snap into place. Optional posts 738 extending from an inner wall of the cover 730 also bear against filter material 720 from the other side, thereby retaining it in a desirable location.

FIG. 8 is a drawing which shows the unit assembled, with baffle 712 being visible through opening 710. A portion of filter-receiving portion 732 is also visible through the cover 730. In operation, the user places the in-mouth portion 704 in their mouth, with their lips closed, and with the opening 710 being oriented downwardly or away from the source of the spray, as the case might be.

1. An in-mouth filter for sunless, liquid spray tanning, comprising:
a piece of filter material;
a body having an in-mouth portion and a filter-receiving portion; and
wherein the filter-receiving portion includes a sidewall with an opening for breathing through the filter material and a closed end to shield liquid tanning spray directed at a user.

2. The in-mouth filter of claim 1, wherein the filter material is a cotton pad.

3. The in-mouth filter of claim 1, further including one or more filter-material retaining features within the body.

4. The in-mouth filter of claim 1, wherein the in-mouth portion is generally oval in cross section.
